(19) United States
(12) Patent Application Publication
(10) Pub. No.: US 2025/0231719 A1
(43) Pub. Date: Jul. 17, 2025

(54) INSPECTION APPARATUS AND IMAGE PROCESSING METHOD

(71) Applicant: CANON KABUSHIKI KAISHA, Tokyo (JP)

(72) Inventor: DAISUKE NAGAO, Saitama (JP)

(21) Appl. No.: 19/021,404

(22) Filed: Jan. 15, 2025

(30) Foreign Application Priority Data
Jan. 17, 2024 (JP) 2024-005122

(51) Int. Cl. G06F 3/12; G06T 7/00

(52) U.S. Cl. CPC G06F 3/1204; G06F 3/1208; G06F 3/1256; G06F 3/1257; G06T 7/0002; G06T 2207/30144

(57) ABSTRACT

The present disclosure enables the convenient setting of appropriate inspection criteria for printed matters. A control unit of an inspection PC waits until an image for printing is received, and, upon receiving the image for printing, analyzes the layout of the image for printing, detects an object composing the image for printing, and calculates an inspection area. The control unit displays the inspection area and inspection level of the detected object in an inspection level numeric value box on a UI of the inspection PC. The inspection level for each object is set as the average value of the inspection levels used in the past ten inspections for that object. The control unit acquires the contents of the inspection level numeric value box and the types of objects corresponding to the respective numeric values and updates the inspection levels in a predetermined inspection level table.

### BACKGROUND

### Field

The present disclosure relates to an image processing technique for inspecting the quality of a printed matter.

### Description of the Related Art

There is a known inspection apparatus that uses a scanner to read a printed matter printed by a printing apparatus and detects defects such as stains or misprints on the printed matter from the read image. To perform the inspection, it is necessary to set an inspection area to an area desired to be inspected on the read image, and to set a defect detection criterion for the inspection area. Japanese Patent Laid-Open No. 2021-078082 discloses a technique for setting an inspection area and inspection criterion according to an object based on user input in order to appropriately perform such an inspection. In a case where areas to which inspection criteria are applied overlap in an image, the areas are presented so that the user can easily understand whether the inspection will be performed according to the inspection criterion desired by the user.

However, in the technique described in Japanese Patent Laid-Open No. 2021-078082, the user sets the inspection criterion for each object by manual input, which creates the problem that the effort and time required for user input increases with an increase in the number of objects for which inspection criteria are individually set.

### SUMMARY

The present disclosure is characterized by an inspection apparatus for performing an inspection of a printed matter, the inspection apparatus including: a setting unit configured to set an inspection level, which defines a defect detection criterion for the printed matter, according to feature information of the printed matter; and a storage unit configured to store the inspection level used in the inspection performed by the inspection apparatus in association with the feature information, wherein the setting unit updates the inspection level to be set in the inspection apparatus based on the inspection level stored in the storage unit.

Further features of the present disclosure will become apparent from the following description of exemplary embodiments with reference to the attached drawings.

### BRIEF DESCRIPTION OF THE DRAWINGS

FIG. 1 is a diagram illustrating an example of the overall configuration of the image forming apparatus 1000 in an embodiment;

FIG. 2 is a diagram for explaining the flow of various data in an embodiment;

FIG. 3A is a flowchart for explaining the processing on the image forming apparatus main body side in the processing of inspecting a printed matter in the first embodiment;

FIG. 3B is a flowchart for explaining the processing on the image forming apparatus main body side in the processing of inspecting a printed matter in the first embodiment;

FIG. 4 is a flowchart for explaining the processing on the inspection PC side in the processing of inspecting a printed matter in the first embodiment;

FIG. 5 is a diagram illustrating an example of an image for printing;

FIG. 6 is diagram for explaining the inspection areas of detected objects in the image for printing;

FIG. 7 is a diagram for explaining an inspection condition setting screen displayed on a UI of the inspection PC in the first embodiment;

FIG. 8 is an inspection level table used to determine the recommended values to be displayed in an inspection level numeric box in the first embodiment;

FIG. 9 is a diagram for explaining an inspection condition setting screen displayed on a UI of the inspection PC in the second embodiment;

FIG. 10 is an inspection level table used to determine the recommended value to be displayed in an inspection level numeric value box in the second embodiment;

FIG. 11 is a diagram for explaining an inspection condition setting screen displayed on a UI of the inspection PC in the third embodiment; and

FIG. 12 is a diagram for explaining an inspection level table used to determine the recommended values to be displayed in an inspection level numeric value box in the third embodiment.

### DESCRIPTION OF THE EMBODIMENTS

Hereinafter, detailed explanations are given of embodiments of the present disclosure with reference to the accompanying drawings. Noted that the following embodiments are not intended to limit the present disclosure according to the scope of the patent claims and that every combination of the characteristics explained in the present embodiments is not necessarily essential to the solution in the present disclosure.

### First Embodiment

Hereinafter, with reference to the accompanying drawings, an explanation is given of an image formation apparatus according to the present embodiment.

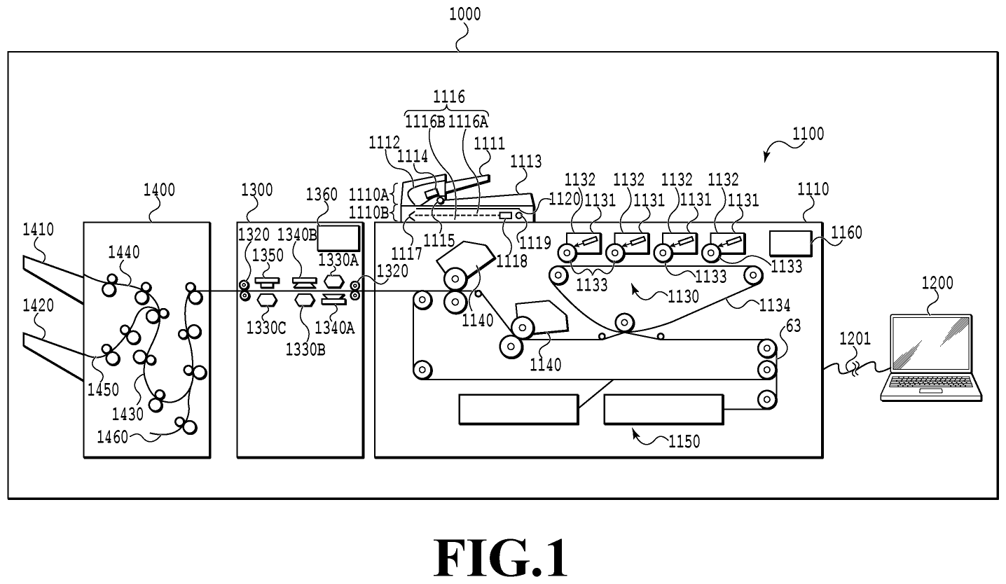

FIG. 1 is a diagram illustrating an example of the overall configuration of the image forming apparatus 1000 according to the first embodiment to which the present embodiment is applied. As illustrated in FIG. 1, the image forming apparatus 1000 is equipped with the image forming apparatus main body 1100, the image reading apparatus 1300, and the sheet discharging unit 1400. The client PC 1200, which is an example of a terminal device, is connected to the image forming apparatus main body 1100 via the communication line 1201 such as a network or the like. The client PC 1200 transmits print data to the image forming apparatus main body 1100. The image forming apparatus main body 1100 receives the print data transmitted by the client PC 1200 via the communication line 1201, and performs printing based on the received print data. The reading unit 1110 is installed on the upper part of the image forming apparatus main body 1100. The reading unit 1110 is equipped with the ADF 1110A and the document reading unit 1110B. The ADF 1110A is equipped with the document tray 1111, the sheet path 1112, the sheet discharge tray 1113, the contact image sensor 1114, the density reference member 1115, etc. The density reference member 1115 is used during shading correction of the ADF 1110A. The document reading unit 1110B is equipped with the document illumination unit 1116, the reflecting mirror 1117, the condenser lens 1118, the sensor 1119, the platen glass 1120, and the like. The reading unit 1110 separates and feeds out the documents set in the document tray 1111 one sheet at a time, conveys the sheets in the sub scanning direction along the sheet path 1112, on which the contact image sensor 1114 is arranged, and discharges the sheets onto the sheet discharge tray 1113. The document illumination unit 1116 is equipped with the lamp 1116A and the mirror 1116B. While the documents are conveyed in the sub scanning direction along the sheet path 1112, a reading operation is repeatedly executed on a line-by-line basis in the main scanning direction by the document illumination unit 1116, the reflecting mirror 1117, the condenser lens 1118, and the sensor 1119.

The image forming apparatus main body 1100 is equipped with the control unit 1160, the image forming unit 1130, the fixing unit 1140, the sheet feeding unit 1150, and the like. The control unit 1160 performs image processing on the document image data acquired from the client PC 1200 to generate an image for printing, and transmits the image to the image forming unit 1130. Details are described hereinafter. Further, the control unit 1160 controls the image forming unit 1130, the fixing unit 1140, the sheet feeding unit 1150, and the like. The image forming unit 1130 is equipped with the exposure devices 1131, the development devices 1132, the photosensitive drums 1133, and the transfer belt 1134. The image forming unit 1130 develops the image by supplying different color toners to the photosensitive drums 1133 using the exposure devices 1131 based on the print image data received from the control unit 1160 or the image data of a document read by the reading unit 1110. The image forming unit 1130 transfers the toner image developed on the photosensitive drums 1133 onto a sheet supplied from the sheet feeding unit 1150 using the transfer belt 1134. In the image forming unit 1130, the fixing unit 1140 melts the toner of the toner image transferred onto the sheet, thereby fixing the color image onto the sheet. The image reading apparatus 1300 is arranged in an in-line manner on the downstream side of the image forming apparatus main body 1100, and reads the image printed on one or both sides of the sheet on which images are formed. Note that, in the following explanation, it is assumed that the image reading apparatus 1300 is arranged in an in-line manner, but it is also possible that the image reading apparatus 1300 is arranged on the downstream side of the image forming apparatus main body 1100 in an off-line manner.

The image reading apparatus 1300 is equipped with the control unit 1360, the image reading unit 1340A, the image reading unit 1340B, the colorimeter 1350, the background members 1330A to 1330C, the conveying unit 1320, and the conveying path 1310. The control unit 1360 transmits the read image acquired from the image reading unit 1340 to the control unit 1160. Details are described hereinafter. Further, the control unit 1360 controls the conveying unit 1320, the background member 1330, the image reading unit 1340, the colorimeter 1350, and the like. The conveying path 1310 is the path through which the sheets pass. The conveying unit 1320 conveys the sheets on which an image is formed. Thus, the sheets are conveyed along the conveying path 1310 by the drive of the conveying unit 1320. For example, once the image reading apparatus 1300 receives a sheet supplied from the image forming apparatus main body 1100, the image reading apparatus 1300 causes the image reading units 1340A and 1340B and the colorimeter 1350 to read the image formed on the sheet. The result of reading the image (hereinafter referred to as a read image) may be output to the image forming apparatus main body 1100 or the like. Specifically, each of the image reading unit 1340A and the image reading unit 1340B is arranged at a position facing either the front side or the back side of the sheet passing through the conveying path 1310. The image reading unit 1340A is arranged at a position where the back side of the sheet is read. The results of reading by the image reading unit 1340A may be used, for example, to check for a shift between the front side and the back side of images printed on the sheet, to check for the presence or absence of an unexpected image, or the like. On the other hand, the image reading unit 1340B is arranged at a position where the front side of the sheet is read. Specifically, the image reading unit 1340B reads an image printed on the sheet. As the sheet is conveyed, the image reading unit 1340B reads the colors of the image formed on the sheet along the perpendicular direction (the direction perpendicular to the advancing direction of the sheet), that is, along the main scanning direction. Note that the image reading unit 1340A and the image reading unit 1340B are collectively referred to as the image reading unit 1340. The image reading unit 1340 is configured with, for example, CCD sensor type or CIS type scanners. The background members 1330A to 1330C are collectively referred to as the background member 1330.

The sheet discharging unit 1400 has the sheet discharge destinations 1410 and 1420; the conveying paths 1430, 1440, and 1450; and the inverting unit 1460. The sheets that pass through the image reading unit passes through the conveying path 1430, and are conveyed from the conveying path 1440 in a case where the sheet discharge destination 1410 is used, and from the conveying path 1450 in a case where the sheet discharge destination 1420 is used. The inverting unit 1460 inverts the sheets once so that the orientation of the sheets going out is the same as the orientation of the sheets coming in. The sheet discharge destination for the printed matter may be different; for example, the sheet discharge destination 1410 may be used in a case where the inspection result is normal (OK), and the sheet discharge destination 1420 may be used in a case where the inspection result is abnormal (NG).

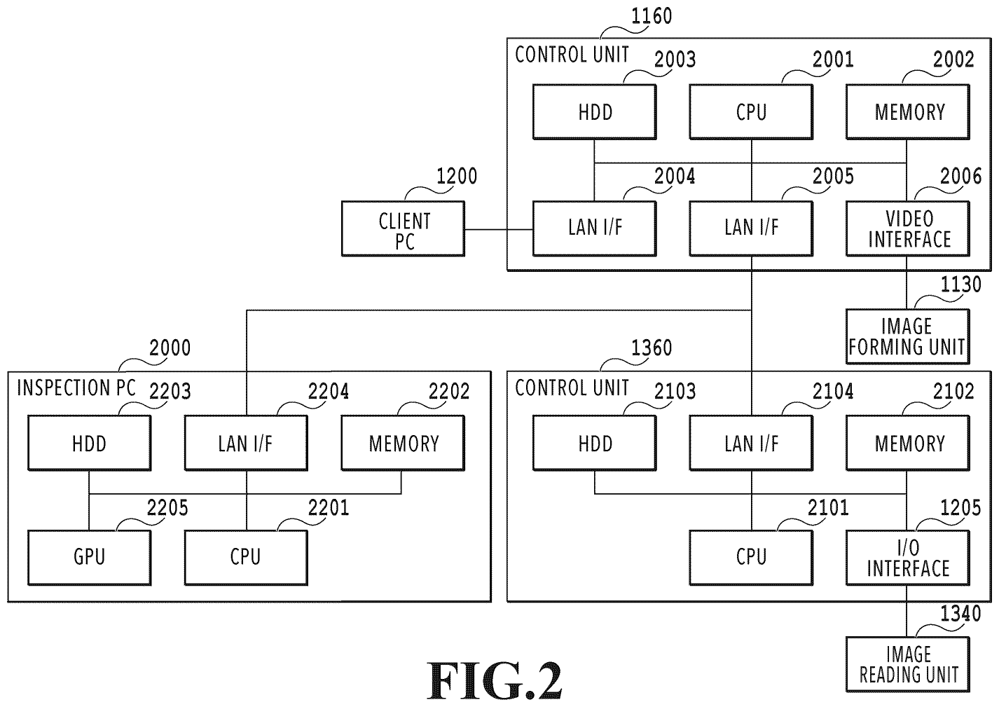

Next, with reference to FIG. 2, an explanation is given of the control for inspecting the finish of a printed matter.

The control unit 1160 of the image forming apparatus main body 1100 is equipped with the control unit 2001, such as a CPU or the like, and the memory 2002, such as a ROM and RAM. The image forming apparatus main body 1100 is further equipped with the HDD 2003, the LAN interfaces 2004 and 2005 as communication interfaces, and the video interface 2006 for outputting image data to the image forming apparatus. The control unit 2001 reads out a program from the memory 2002 in accordance with the process content and executes the program, so as to control the operation of the image forming apparatus main body 1100. The various data stored in the HDD 2003 is referred to in a case where the control unit 2001 controls the operation of the image forming apparatus main body 1100. Note that the HDD 2003 is not limited to a HDD, but may be another storage device such as an SSD, a memory card, or the like.

The LAN interface 2004 is a communication interface for receiving print data and the like from the client PC 1200. The print data has a data structure including a PJL (Print Job Language) part and a PDL (Page Description Language) part that follows it, for example. The PJL part is a printing command language for controlling the image forming apparatus main body 1100. The PDL part is a page description language. Further, the LAN interface 2005 is a communication interface for receiving images from the image reading apparatus 1300.

The control unit 2001 performs screen processing, that is, raster image processing to create halftone dots, so that the print data generated by the client PC 1200 can be printed by the image forming apparatus main body 1100. Raster image processing, or RIP, generates raster images. A raster image is the data of a rasterized image, that is, image data constituting a so-called RIP image. The generated raster image is saved in the HDD 2003. Further, in a case where printing is executed, the control unit 2001 reads out the raster image saved in the HDD 2003, and performs further image correction. In a case where image processing is performed, the control unit 2001 performs the image processing, generates an image for printing, and saves the image in the HDD 2003. Further, the control unit 2001 transmits the image for printing as a video signal to the image forming unit 1130, and the image is formed on a sheet by the image forming unit 1130. Note that the HDD 2103 is not limited to a HDD, but may be another storage device such as an SSD, a memory card, or the like.

The image formed on the sheet is read by the image reading apparatus 1300. The control unit 1360 of the image reading apparatus 1300 is equipped with the control unit 2101, such as a CPU or the like, and the memory 2102, such as a ROM and RAM. The control unit 1360 is further equipped with the HDD 2103, the LAN interface 2104 as a communication interface, and the I/O interface 2105 that acquires read image data acquired by the image reading unit 1340. The control unit 2101 reads out a program from the memory 2102 in accordance with the process content and executes the program, so as to control the operation of the image reading apparatus 1300. The various data stored in the HDD 2103 is referred to in a case where an example of the control unit, such as the control unit 2101, controls the operation of the image reading apparatus 1300.

The read image is transmitted via the control unit 2101 to the control unit 1160 through the LAN interface 2104. The control unit 2001 of the control unit 1160 that receives the read image compares the raster image with the read image and determines whether or not there is an abnormality in the printed matter, thereby inspecting the finish of the printed matter. Details are described hereinafter.

The inspection PC 2000 represents a control configuration for inspecting the finish of a printed matter in the present embodiment. The inspection PC 2000 is equipped with the control unit 2201, such as a CPU or the like, and the memory 2202, such as a ROM and RAM. Further, the inspection PC 2000 is equipped with the HDD 2203 and, as a communication interface, the LAN interface 2204. The control unit 2201 reads out a program from the memory in accordance with the process content and executes the program, so as to control the operation of the inspection PC 2000. The various data stored in the HDD 2203 is referred to in a case where the control unit controls the operation of the inspection PC 2000. Further, the GPU 2205 is a processor that performs calculation processing necessary for image processing, and executes commands related to the image processing from the control unit 2201. Note that the HDD 2203 is not limited to a HDD, but may be another storage device such as an SSD, a memory card, or the like.

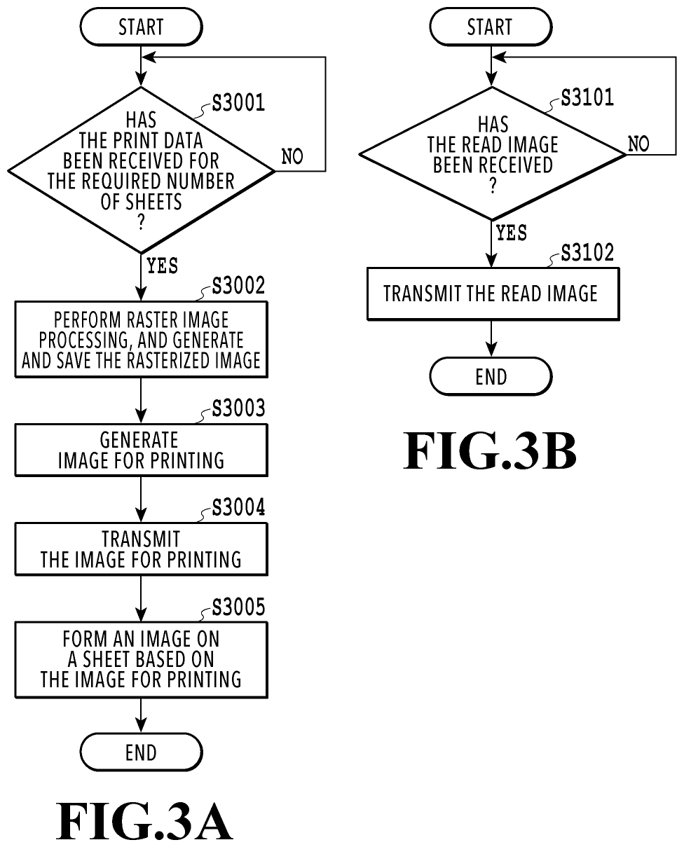

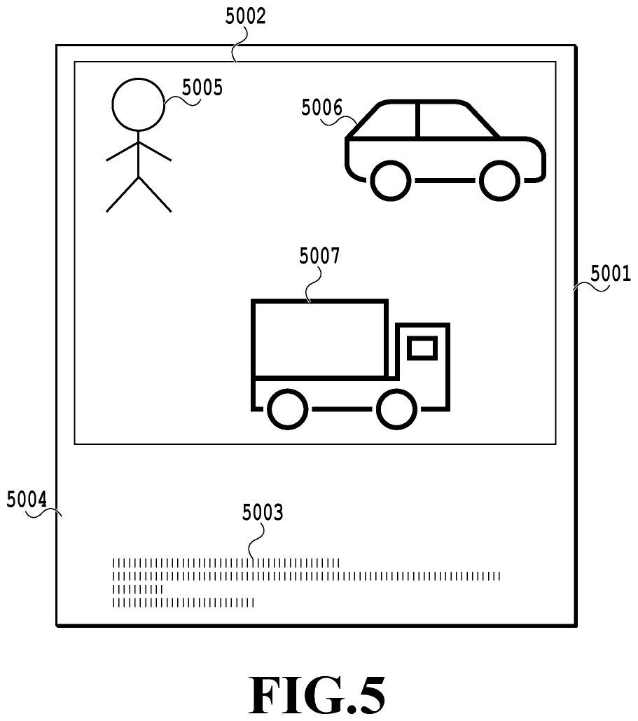

FIG. 3A and FIG. 3B are flowcharts for explaining the processing performed on the image forming apparatus main body 1100 side among the processing for inspecting the finish of a printed matter in the first embodiment. In the present embodiment, an explanation is given of an illustrative example of a case where print data including the image illustrated in FIG. 5 is input and printed, and an inspection is performed on that printed matter. Note that S3001 to S3005 in the flowchart are implemented by the control unit 2001 (a CPU or the like) reading out and executing a program stored in the memory 2002. S3101 and S3102 in the flowchart are implemented by the control unit 2101 (a CPU or the like) reading out a program stored in the memory 2102. S4001 to S4013 in the flowchart are implemented by the control unit 2201 (a CPU or the like) of the inspection PC calling up a program stored in the memory 2202.

The control unit 2001 of the image forming apparatus main body 1100 starts processing, for example, once the power is turned on.

In S3001, the control unit 2001 waits until an image for printing is received, and once the print data is received from the client PC 1200, the processing proceeds to S3002.

In S3002, the control unit 2001 performs raster image processing on the received print data, for example, going through a display list to rasterize the print data (PDL or the like) to generate a raster image, and saves the raster image in the HDD 2003.

In S3003, the control unit 2001 generates the image for printing based on the print settings information from the raster image generated in S3002. Here, the print settings information includes information related to the finish of printed matters, such as the magnification, the color adjustment, and the addition of page numbers.

In S3004, the control unit 2001 sends the image for printing generated in S3003 to the inspection PC 2000.

In S3005, the control unit 2001 forms the image on a sheet based on the image for printing, and the processing ends.

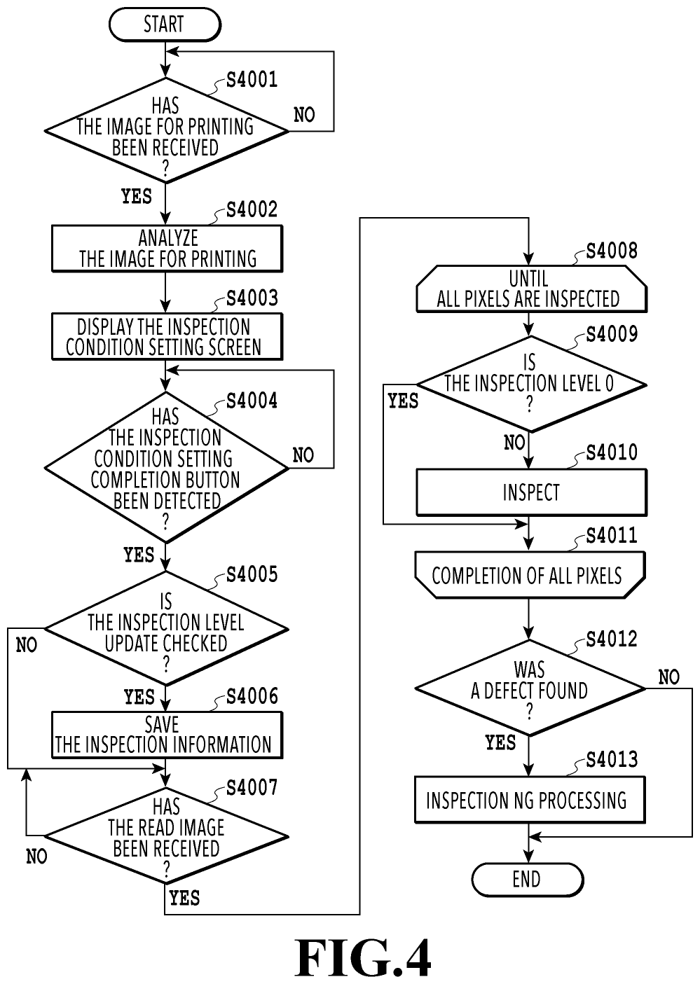

FIG. 4 is a flowchart for explaining the processing performed on the inspection PC 2000 side among the processing for inspecting the finish of a printed matter in the first embodiment.

In S4001, the control unit 2201 of the inspection PC waits until an image for printing is received, and receives an image for printing.

In S4002, the control unit 2201 analyzes the layout of the image for printing, detects the objects that constitute the image for printing, and calculates the inspection area. Here, information related to the detected objects constituting the image for printing is used as feature information of the printed matter.

FIG. 5 is a diagram for explaining the detection of objects, which are elements constituting an image for printing, and the inspection area. First, the layout analysis is performed on the image for printing, and detection of an image area, a text area object, and a background image object is performed from the image for printing. The background area object refers to the area of the entire image for printing excluding the image area and text area object. Further, for layout analysis of the image for printing, a machine learning model that has been trained to analyze layouts saved in advance in the HDD 2203 is used. As an example of the machine learning model used for layout analysis, PubLayNet (2021, Zhejiang Shen et al.), which has been trained to analyze layouts, can be mentioned. The method for analyzing the layout is not limited to a machine learning model, and texts and images may also be detected by analyzing a histogram of brightness values. In the present embodiment, the image area 5002, the text area object 5003, and the background area object 5004 are detected from the image for printing 5001 by layout analysis.

Furthermore, the image area 5002 is analyzed to detect various objects within the image area 5002. To detect an object within the image area 5002, a machine learning model trained to detect objects within images saved in advance in the HDD 2203 is used. As an example of the machine learning model used for object detection, Detectron2 (Facebook AI Research) can be mentioned. In the example illustrated in FIG. 5, the face object 5005, the passenger car object 5006, and the truck object 5007 are detected from the image area by object analysis.

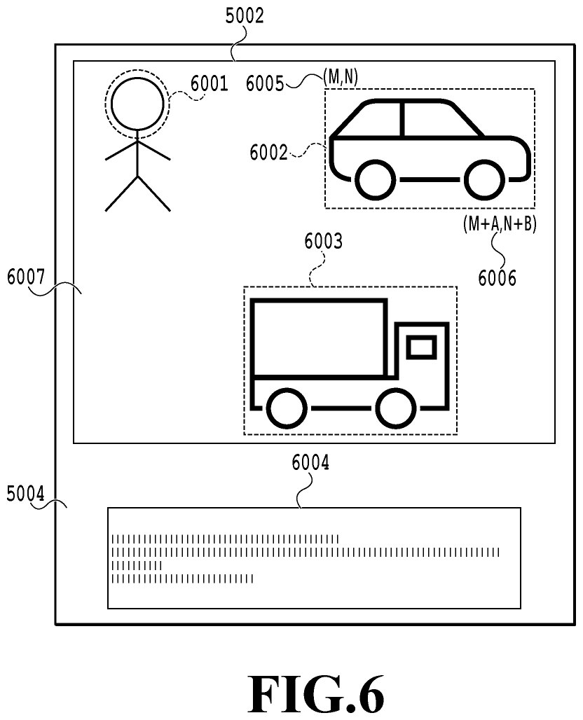

FIG. 6 is a diagram for explaining the inspection area of detected objects. The inspection area is configured with graphic information surrounding an object and coordinate information indicating the position of an object. FIG. 6 shows how the inspection area for each object is set. In the present embodiment, the graphic information includes information indicating the shape and size, such as a rectangle or an ellipse as in the inspection areas 6001 to 6004 illustrated in FIG. 6, and the size is selected so that the dimension enclosing the object is the minimum. The coordinate information is information that indicates the coordinates used to determine the position of the inspection area of an object. In a case where the graphic information is a rectangle, the coordinates are the upper left and lower right vertex coordinates, and, in a case where the graphic information is an ellipse, the coordinates are the upper left and lower right vertex coordinates of a rectangle that circumscribes the ellipse. For example, for the rectangular inspection area 6002, the upper left vertex coordinate (M, N) 6005 and the lower right vertex coordinate (M+A, N+B) 6006 are held as the coordinate information. Although two vertex coordinates are given as an illustrative example of the coordinate information, it is also possible to use information that uniquely defines a rectangle or ellipse, such as one vertex coordinate and the lengths of two orthogonal sides, or the center coordinate and the distance from the center.

Here, the non-inspection area 6007 in which no object is detected within the image area 5002 may be processed as an image area object or as the background object 5004. In the present embodiment, an explanation is given under the assumption that the object is processed as the background object 5004. In an overlapping area of an inspection area and a non-inspection area, the inspection area in which an object is detected is given priority for processing. For example, the area where the inspection area 6003 and the non-inspection area 6007 overlap is processed as the inspection area 6003 in which the truck object 5007 is detected. Further, the inspection level that defines the detection criterion for defects in a printed matter, which is set for each inspection area, is set according to the object included in each inspection area, based on the inspection level that is set in advance for each object. In a case where multiple objects are detected in the same inspection area, the inspection level of that inspection area is set to the highest inspection level among the inspection levels set for the respective detected objects. The inspection level set in an inspection area is applied to all objects within the inspection area. For an area where inspection areas overlap, the highest inspection level among the inspection levels of the overlapping multiple inspection areas is set.

In S4003, the control unit 2201 causes a UI (not illustrated in the drawings) included in the inspection PC 2000 to display an inspection condition setting screen which shows the inspection areas of detected objects and the inspection levels.

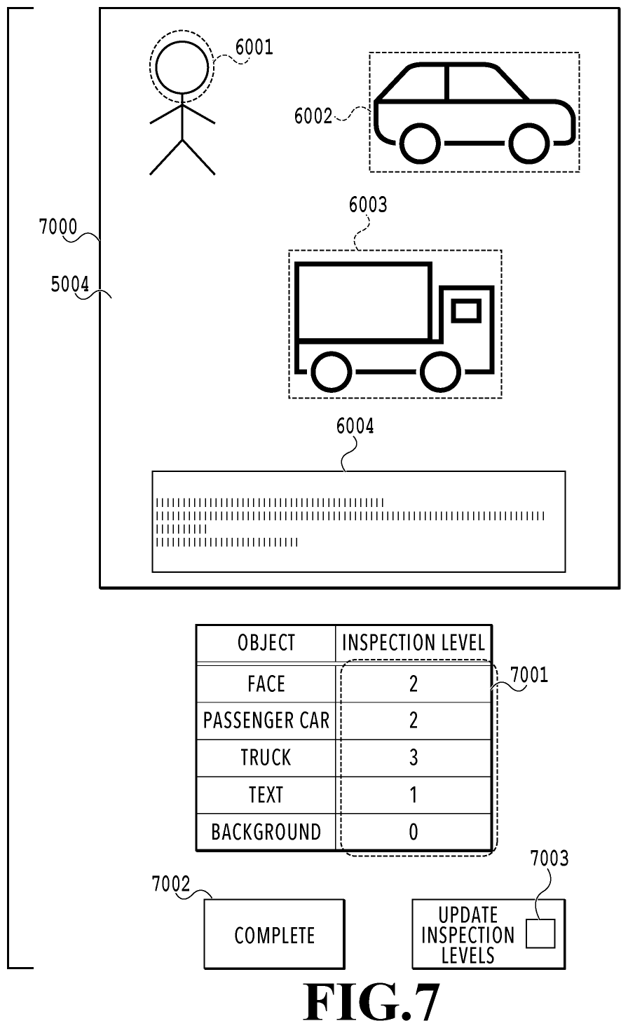

FIG. 7 illustrates an example of the inspection condition setting screen displayed on the UI of the inspection PC 2000 in the present embodiment. This inspection condition setting screen is configured with the preview area 7000 for the objects and inspection areas, the inspection level numeric value box 7001, the inspection condition setting completion button 7002, and the inspection level update check box 7003. The user can check the inspection level for each object from the value displayed in the inspection level numeric value box 7001, and can perform a change of the inspection level as necessary. In the present embodiment, it is assumed that the inspection level has six stages, from 0 to 5. Inspection level 5 represents the strictest inspection to be performed, and as the inspection level numeric value decreases, the inspection criterion become more relaxed. That is, the size and density difference of a defect such as a stain or a blotch that is determined to be abnormal is smallest at inspection level 5 and largest at inspection level 1. Inspection level 0 is indicative of “exclusion” of an object from inspection, and no inspection is performed on an object for which inspection level 0 is set. In this way, at each inspection level, different threshold values are set for each parameter, such as the defect size and density difference, which are the detection criteria for defects determined to be abnormal.

The inspection condition setting completion button 7002 is a button for the user to confirm the inspection settings. In a case where the user has completed changing the inspection levels, the user can confirm the inspection settings by pressing the inspection condition setting completion button 7002. The inspection level update check box 7003 is a check box for setting whether or not to update the inspection levels in the later-described inspection level table.

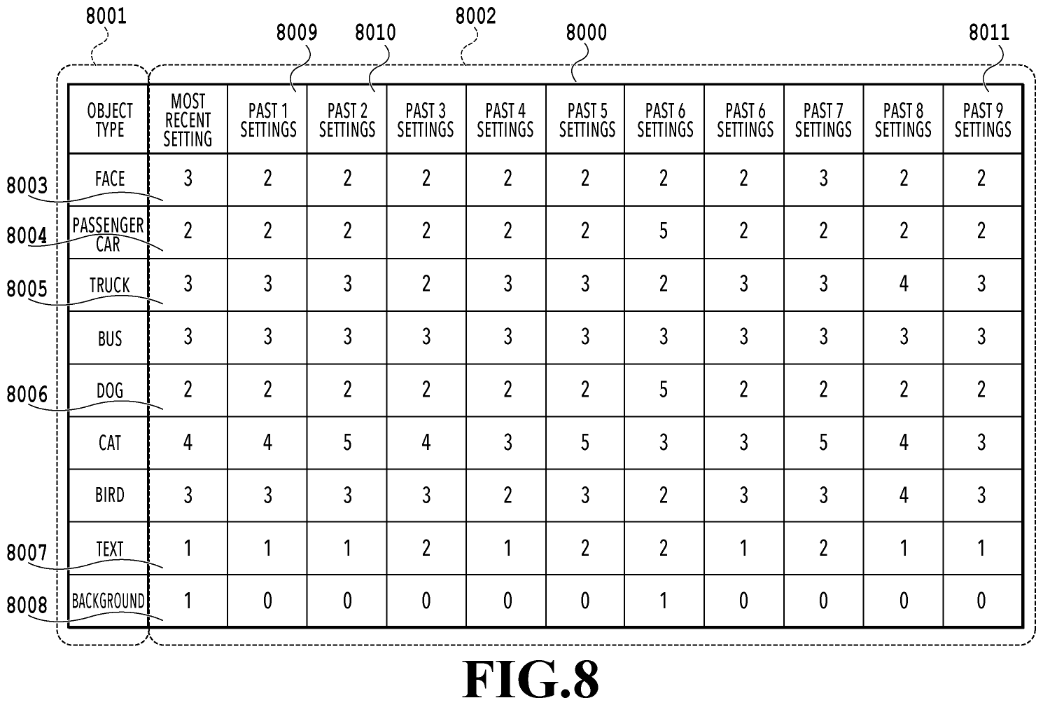

FIG. 8 illustrates the inspection level table used to determine the recommended values to be displayed in the inspection level numeric value box 7001 in the present embodiment. The inspection level table 8000 illustrated in FIG. 8 holds the object types 8001 and the inspection levels 8002 used for each object in the past inspections. The present embodiment is configured to hold the inspection levels for ten inspections, including both the most recent setting and past settings. However, this is not limited to ten inspections, and any number greater than or equal to one may be used, such as 100 or 1000. Further, the user may be allowed to specify how many inspections to hold the inspection levels for. Note that the initial values of the inspection level table 8000 may be set by the user via a UI that is not illustrated in the drawings, or predetermined values may be set. Alternatively, the inspection level table 8000 may also hold incidental information according to the size and shape of the recognized object and its position on the image for printing. In other words, the inspection level table 8000 holds only the inspection level for each past setting, but may also be configured to further hold incidental information indicating the size and shape of the object and its position on the image for printing in addition to the inspection level for each past setting. This makes it possible to calculate a value displayed in the inspection level numeric value box 7001 based only on the inspection levels used for objects that have similar incidental information, even among the same objects. Similarly, object types may be classified according to their positions on the image for printing, for which different inspection levels may be set. Further, regarding the object types, the same objects may be classified as different object types based on their sizes, shapes, and positions on the image for printing, such as “face (large),” “face (medium),” and “face (small),” and different inspection levels may be set for each type. In this way, the inspection level table 8000 is not limited to the form illustrated in FIG. 8, and various modifications may be made.

In the present embodiment, the inspection level for each object displayed in the inspection level numeric value box 7001 is the average value of the inspection levels of the ten inspections including the most recent setting and past settings for each object. For example, the average value of the inspection levels of the past ten inspections for the face object 5005 is 2.2, and thus the decimal point is rounded down to 2. Similarly, the inspection level of the passenger car object 5006 is 2, the inspection level of the truck object 5007 is 3, the inspection level of the text object is 1, and the inspection level of the background object is 0. Note that the values displayed in the inspection level numeric value box 7001 are not limited to the average values of the inspection levels used in a predetermined number of inspections, but may be the inspection levels used most frequently in the past inspections. The values displayed in this inspection level numeric value box 7001 may be values calculated by collecting the inspection level data from multiple inspection apparatuses and using all of the inspection level data used by those multiple inspection apparatuses. Further, in a case where the inspection level table 8000 holds incidental information, the calculation may be performed using only the inspection levels of an object type corresponding to detected objects that are close in size, shape, and position within the image based on the incidental information. Furthermore, a predetermined coefficient may be set for each parameter included in the incidental information, so that the inspection levels corresponding to the incidental information may be calculated by multiplying an inspection level set for each object type by the coefficient corresponding to the incidental information. For example, if the coefficient for a “large” object size is 1, the coefficient for a “medium” object size is 0.5, and the coefficient for a “small” object size is 0, and the inspection level for a face object is 3, then the inspection level depending on the size will be 3 for “large,” 2 for “medium,” and 0 for “small.” The method of calculating the inspection levels to be displayed in the inspection level numeric value box 7001 is not limited to these forms, and various modifications may be made.

In S4004, the control unit 2201 waits until the pressing of the inspection condition setting completion button 7002 is detected, and once it is detected that the inspection condition setting completion button 7002 is pressed, the processing proceeds to S4005.

In S4005, the control unit 2201 determines whether or not the inspection level update check box 7003 is checked. In a case where the inspection level update check box 7003 is checked, the processing proceeds to S4006, and in a case where the inspection level update check box 7003 is not checked, the processing proceeds to S4007.

In S4006, the control unit 2201 acquires the contents of the inspection level numeric value box 7001 and the object types corresponding to the respective numeric values, and updates the inspection levels 8002 of the inspection level table 8000 saved in the HDD 2203. In the present embodiment, the values of the inspection level numeric value box 7001 for the face object, the passenger car object, the truck object, the text object, and the background object are saved in the most recent settings 8003 to 8008, respectively. Further, the most recent settings up to that point are overwritten by the past 1 settings 8009, the past 1 settings 8009 are overwritten by the past 2 settings 8010, and similarly, all the settings up to the past 9 settings 8011 are updated. As a result, the values of the inspection level numeric value box 7001 that are displayed during the product inspection of the next print are calculated based on the values from the most recent settings to the past 9 settings that are updated, and thus it is possible to reduce the number of setting changes made by the user.

In a case where it is determined in S4005 that the inspection levels are not to be updated, the inspection level table 8000 will not be updated. This is to prevent that, in a case where a unique inspection level is set, the value will be saved in the inspection level table 8000, which may affect the inspection levels of subsequent inspections. As a result, even in a case where an inspection is performed by setting a unique inspection level, in subsequent inspections, a standard inspection level suitable for most cases can be displayed in the inspection level numeric value box 7001 without being affected by the unique inspection level.

In S4007, the control unit 2201 waits until the read image is received from the control unit 2101 of the image reading apparatus 1300, and once the read image is received, the processing proceeds to S4008.

Here, an explanation is given of the processing of the control unit 2101 of the image reading apparatus 1300.

In S3101, the control unit 2101 waits until the read image is acquired, and once the read image is acquired, the processing proceeds to S3102.

In S3102, the control unit 2101 transmits the acquired read image to the control unit 1160 and ends the processing.

Here, the explanation returns to the processing performed by the control unit 2201 of the inspection PC 2000. In S4008 to S4011, the control unit 2201 performs the inspection based on the inspection condition settings set in S4003.

In S4008, the control unit 2201 starts inspecting the pixels of the read image received from the control unit 2101 one pixel at a time based on the inspection condition settings saved in the HDD 2203. For this reason, in S4008, the target pixels to be inspected are changed in sequence, and S4008 to S4011 are repeatedly executed until the inspection is completed for all the pixels of the read image.

In S4009, the control unit 2201 determines whether or not the inspection level of the target pixel is 0, and if the inspection level is not 0, the processing proceeds to $4010 to perform the inspection, and if the inspection level is 0, the processing proceeds to S4011 without performing the inspection. Note that an object is configured with multiple pixels, and the inspection level of a target pixel is the inspection level of an object detected in the inspection area that includes the target pixel.

In S4010, the control unit 2201 performs the inspection of the target pixel. Regarding the inspection to be executed, for example, the density value of the target pixel in the read image may be compared with the density value of a pixel in the image for printing at the position corresponding to the target pixel. The inspection result is determined based on whether or not the threshold value corresponding to the inspection level is exceeded. Thus, if the threshold value is exceeded, it is determined to be abnormal, and if the threshold value is not exceeded, it is determined to be normal, and the result is saved in the HDD 2203. The corresponding position may be the pixel with the same coordinates as the target pixel, or, if the position has been corrected, the corresponding position may be the same coordinates as the corrected position. In a case where the inspection is performed by comparing pixels in this way, the threshold value may be a tolerance value for the density difference between the target pixels. Further, in the inspection, instead of the density value, the color difference between corresponding pixels of the image for printing and the read image may be compared with a reference value. The color difference may be represented, for example, as a distance in a color space, and a specific distance in the color space according to the inspection level is set as the threshold value for determining whether or not to be normal, and the stricter the inspection level, the smaller the distance in the color space that is set as the threshold value. The inspection result is determined based on whether or not to be equal to or greater than the threshold value according to the inspection level, and the inspection result is stored in the HDD 2203 as abnormal in a case of being equal to or greater than the threshold value and as normal in a case of being less than the threshold value.

In S4011, if the inspection has not been completed for all the pixels, the control unit 2201 returns the processing to S4008, and the inspection is continued until the inspection is completed for all the pixels. If the inspection has been completed for all the pixels, the processing proceeds to S4012.

In S4012, the control unit 2201 refers to the inspection results saved in the HDD 2203 in S4011, and if the determination is YES, the processing proceeds to S4013, and if the determination is NO, the processing proceeds to S4014 and ends, assuming that the necessary inspections have been completed.

In S4013, the control unit 2201 issues an NG notification which indicates abnormal. Note that the NG notification may be provided in any form as long as the user, a maintenance worker, or the like is notified of the abnormality, and may be displayed on a display panel that is not illustrated in the drawings of the image forming apparatus main body 1100, for example. The notification form of the NG notification is not particularly limited, and may be a notification by audio of a human voice, a notification by a combination pattern of flashing or lighting of one or multiple color patrol lamps. Further, in a case where different sheet discharge destinations are used for printed matters determined to be normal (OK) and printed matters determined to be abnormal (NG), the configuration may be such that a printed matter is discharged to the sheet discharge destination for abnormal (NG) determinations to be indicative of an NG notification.

As described above, by automatically displaying and setting the inspection level corresponding to an object, based on the inspection levels used in past inspections for that object, the work load of the user to manually change the inspection levels can be reduced.

Note that, in the present embodiment, the update processing (S4005 and S4006) for updating the inspection level is performed before the inspection processing (S4008 to S4013) for inspection, but the order of the update processing and the inspection processing may be reversed.

### Second Embodiment

In the first embodiment, in calculating the inspection levels based on the feature information of a printed matter, the inspection levels are calculated on a per object basis. In contrast to this, in the present embodiment, a genre for classifying the type of object is added as feature information of a printed matter, and the inspection level is calculated taking the genre of the object into consideration. Note that, in the explanation of the present embodiment, in principle, identical numbers are assigned to identical configuration requirements and processing steps as in the first embodiment, so that their explanations are omitted. Hereinafter, an explanation is given mainly of the parts that are different from the first embodiment. In principle, the parts not specifically mentioned are similar to those in the first embodiment described above.

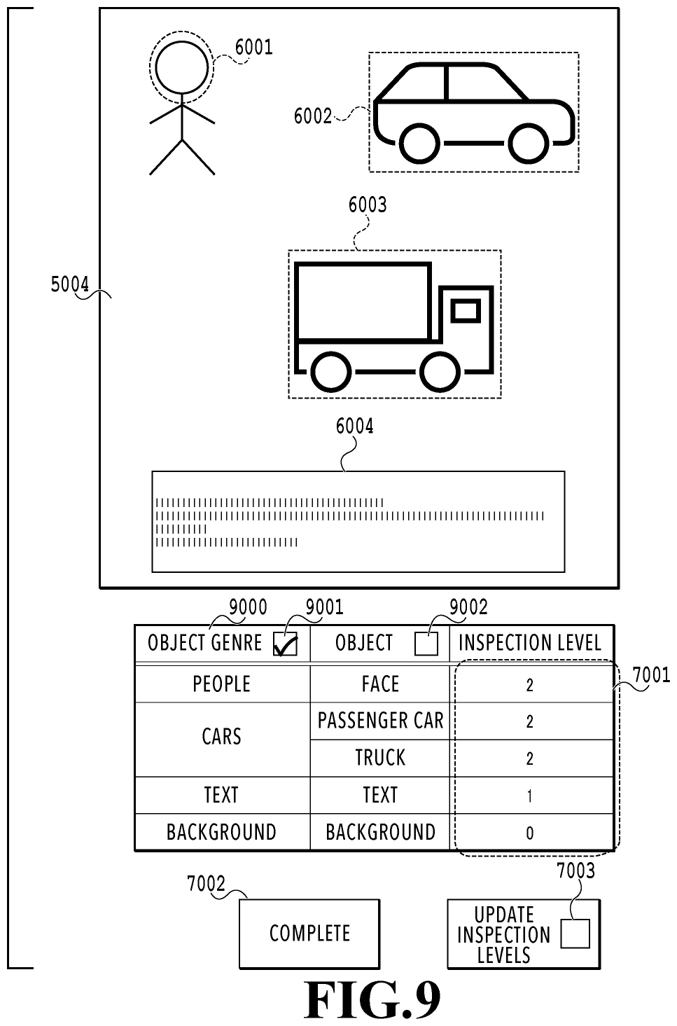

FIG. 9 illustrates the inspection condition setting screen displayed on the UI of the inspection PC 2000 in the present embodiment. The inspection condition setting screen in the present embodiment includes the object genre 9000, the object genre selection check box 9001, and the object selection check box 9002. The object genre 9000 includes multiple types of objects. For example, the car object genre includes the passenger car, truck, and bus objects. Similarly, the animal object genre includes the dog, cat, and bird objects. Here, the relationship between the object genres and the objects may be determined in advance, or may be changeable via a UI that is not illustrated in the drawings as appropriate. The relationship between the object genres and the objects is not limited to these forms.

The object genre selection check box 9001 and the object selection check box 9002 are check boxes for selecting whether the inspection levels are to be calculated based on the object genres or based on the objects. For example, in a case where the object selection check box 9002 is selected, an inspection level of “2” is calculated based on the past inspection levels of a passenger car, and an inspection level of “3” is calculated based on the past inspection levels of a truck. Although the passenger car and the truck belong to the same genre, in a case where the object selection check box 9002 is selected, the inspection levels are calculated separately for the passenger car and the truck. On the other hand, in a case where the object genre selection check box 9001 is selected as illustrated in FIG. 9, the passenger car and the truck are in the same genre, so a common inspection level (inspection level “2” in this case) is calculated for their inspection levels.

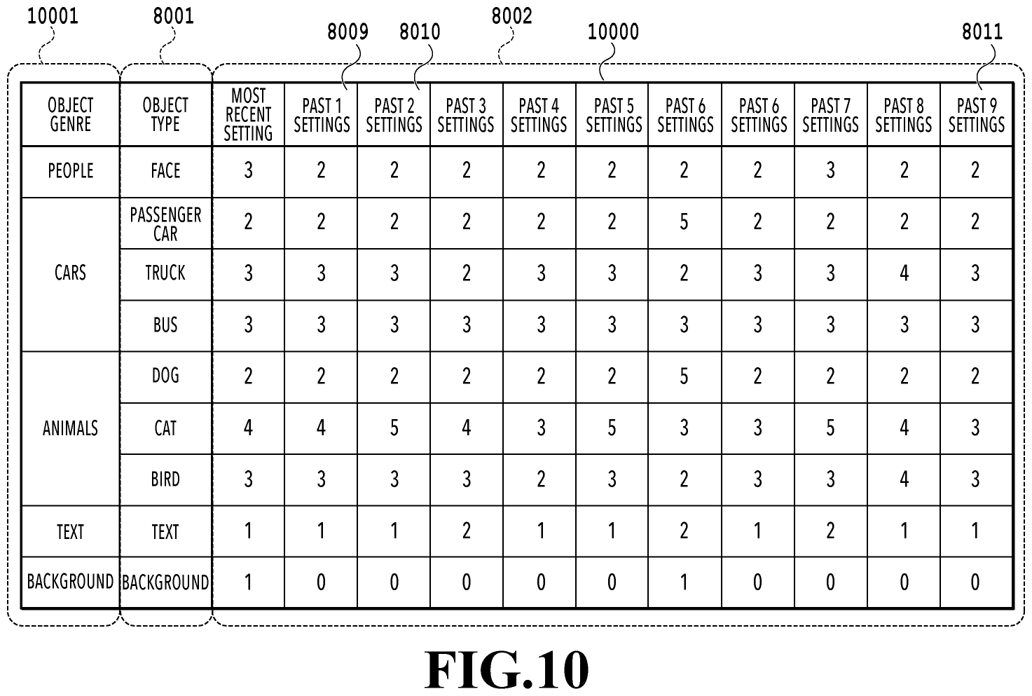

FIG. 10 is the inspection level table 10000 used to determine the recommended values to be displayed in the inspection level numeric value box in the present embodiment. The object genres 10001 and the object types 8001 are associated with each other to save the inspection levels. In the present embodiment, in a case where the object genre selection check box 9001 is selected, the values in the inspection level numeric value box 7001 are set to the average values of the past ten inspections of all objects in the respective object genres. For example, since the average value of all objects in the car object genre is “2,” both the passenger car object and the truck object are calculated and displayed as “2” in the inspection level numeric value box 7001. The inspection level for each genre may be selected from among multiple inspection levels calculated for each of the multiple objects within the same genre, or a single inspection level may be calculated for each genre without distinguishing the multiple objects within the same genre.

As described above, in the present embodiment, in a case where there are multiple objects of the same object genre within an image, the user can automatically set, with a simple operation, the inspection level for each object genre based on the inspection levels used in past inspections.

### Third Embodiment

In the first and second embodiments, the inspection levels are calculated using information about the objects in the image for printing as the feature information of the printed matter. In contrast, in the present embodiment, for printed matters such as a business form in which objects recognized from an image are not important, the inspection level can be calculated according to the type of printed matter. Note that, in principle, identical numbers are assigned to identical configuration requirements and processing steps, so that their explanations are omitted. Hereinafter, an explanation is given mainly of the parts that are different. In principle, the parts not specifically mentioned are similar to the first and second embodiments described above.

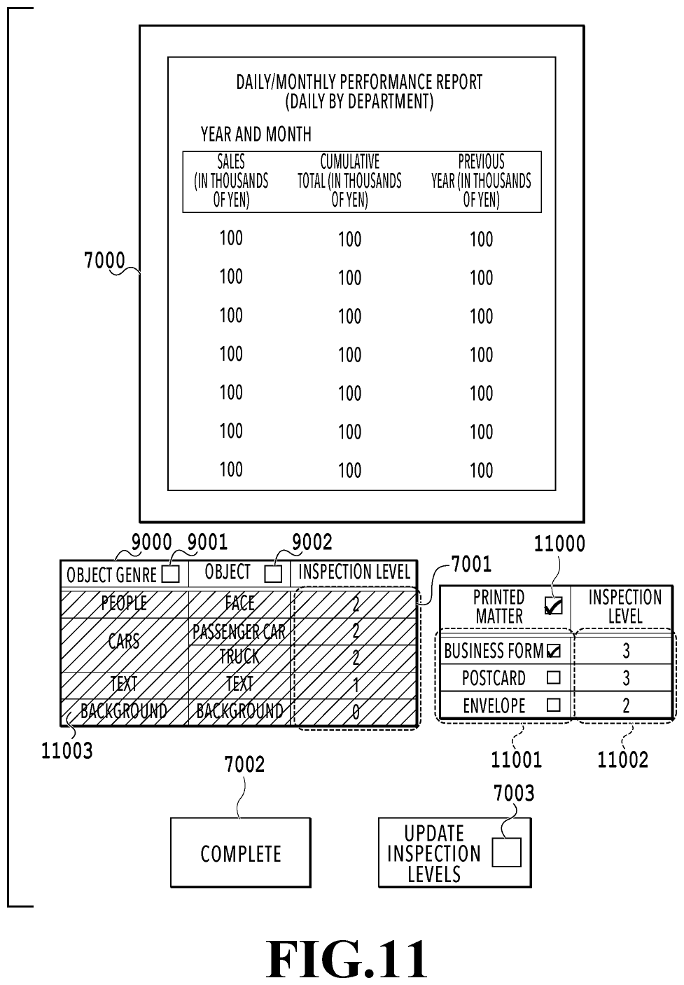

FIG. 11 illustrates the inspection condition setting screen displayed on the UI of the inspection PC 2000 in the present embodiment. The inspection condition setting screen in the present embodiment includes the preview area 7000, the printed matter check box 11000, the printed matter type check box 11001 for selecting the type of printed matter, and the inspection level numeric value box 11002 corresponding to the printed matter. The printed matter check box 11000 is for switching whether or not to set the inspection levels depending on the printed matters. In the present embodiment, the printed matter check box 11000 has a mutually exclusive relationship with the object genre selection check box 9001 and the object selection check box 9002. In a case where the printed matter check box is checked, the diagonal lines 11003 are displayed in the display area for the object genres and the inspection condition settings for the respective objects. In the present embodiment, business forms, postcards, and envelopes are given as illustrative examples of types of printed matter, but the types of printed matter are not limited to these. The printed matter type check box 11001 is a check box for selecting the printed matter. In the present embodiment, an example is illustrated where business form is checked.

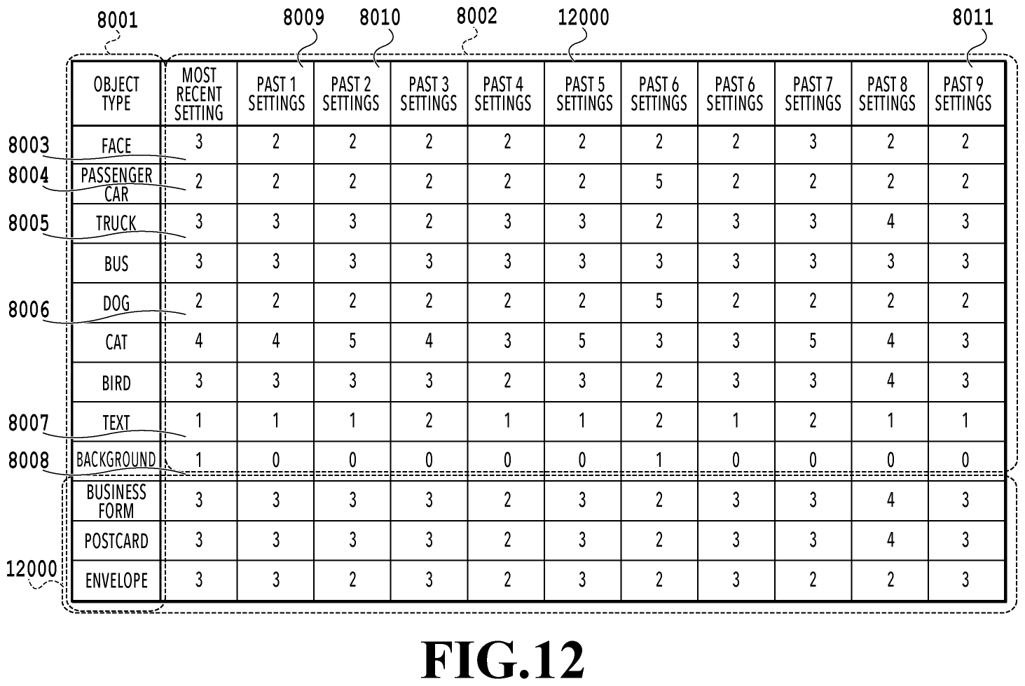

FIG. 12 is the inspection level table 12000 used to determine the recommended values to be displayed in the inspection level numeric value box in the present embodiment. Each type of printed matter, such as business form, postcard, or envelope, is processed as an object, and its inspection level is saved. In the present embodiment, the values of the inspection level numeric value box 11002 are calculated from the average values of the past ten inspection levels, as with the first embodiment, by processing the printed matter in a similar manner as an object. For example, the average value of the business form object is 2.9, so 3 is displayed. In the present embodiment, in a case where the printed matter check box 11000 is selected, the same inspection level is applied to all the objects included in the image for printing.

Note that, although the printed matter check box 11000 has a mutually exclusive relationship with the object genre selection check box 9001 and the object selection check box 9002, they may coexist. For example, the inspection level for the printed matter object may be applied only to the background object, and an inspection level for each object or object genre may be applied to each object included in the image for printing. The settings related to the printed matter and the objects or the object genres are not limited to those in the present embodiment, and various modifications can be made. Further, the type of printed matter may be identified based on user input, or may be identified from the image for printing by the control unit 2201 using a machine learning model or the like.

As described above, in the present embodiment, the type of printed matter itself is processed as an object, and the inspection level is calculated for each printed matter, thereby allowing the user to automatically set, with a simple operation, the inspection level for each type of printed matter, based on the inspection levels used in previous inspections.

The present disclosure is not limited to the above-mentioned first, second, and third embodiments, and various modifications (including organic combinations of the respective embodiments) are possible based on the spirit of the present disclosure, and these are not excluded from the scope of the present disclosure. In other words, the present disclosure also includes configurations that combine the above-described embodiments and their modification forms.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, an appropriate inspection criterion can be easily set for a printed matter.

This application claims the benefit of Japanese Patent Application No. 2024-005122 filed Jan. 17, 2024, which is hereby incorporated by reference wherein in its entirety.

What is claimed is:

1. An inspection apparatus for performing an inspection of a printed matter, the inspection apparatus comprising:
a setting unit configured to set an inspection level, which defines a defect detection criterion for the printed matter, according to feature information of the printed matter; and
a storage unit configured to store the inspection level used in the inspection performed by the inspection apparatus in association with the feature information,
wherein the setting unit updates the inspection level to be set in the inspection apparatus based on the inspection level stored in the storage unit.

2. The inspection apparatus according to claim 1,
wherein the setting unit includes
an acquisition unit configured to acquire an image for printing used for printing the printed matter, and
a first detection unit configured to detect an object from the image for printing acquired by the acquisition unit,
wherein the setting unit uses information related to the object detected by the first detection unit as the feature information.

3. The inspection apparatus according to claim 2,
wherein the setting unit sets the inspection level for each object based on the feature information.

4. The inspection apparatus according to claim 3,
wherein the setting unit sets an inspection area corresponding to the object and, for the pixels included in the inspection area, set the inspection level that is set for the object corresponding to the inspection area.

5. The inspection apparatus according to claim 4,
wherein, for pixels included in an overlapping area of a plurality of the inspection areas, the setting unit sets the inspection level as the highest inspection level among the inspection levels set for the objects corresponding to the overlapping plurality of the inspection areas.

6. The inspection apparatus according to claim 2,
wherein the setting unit includes a specification unit configured to specify the type of the printed matter based on the information related to the object detected by the first detection unit, and uses the specified type of the printed matter as the feature information.

7. The inspection apparatus according to claim 2,
wherein, regarding the feature information of the printed matter, a second detection unit configured to detect the type of the object from the image for printing is further comprised, and
the setting unit sets the inspection level for each genre into which the types of the objects detected by the second detection unit are classified.

8. The inspection apparatus according to claim 2,
wherein the storage unit stores, in addition to the inspection level, incidental information related to at least one of the size, shape, and position on the image for printing of the object, and
the setting unit updates the set inspection level to an inspection level calculated based on the inspection level and incidental information stored in the storage unit.

9. The inspection apparatus according to claim 1,
wherein the setting unit includes a reception unit configured to receive information indicating the type of the printed matter as the feature information from a user.

10. An image processing method comprising:
setting an inspection level, which defines a defect detection criterion for a printed matter, to an inspection apparatus, which performs an inspection of the printed matter, according to feature information of the printed matter; and
storing, in a storage device, the inspection level used in the inspection performed by the inspection apparatus,
wherein, in the setting, the inspection level to be set in the inspection apparatus is updated based on the inspection level stored in the storage device.
